(19) United States
(12) Patent Application Publication
(10) Pub. No.: US 2004/0004632 A1
(43) Pub. Date: Jan. 8, 2004

(54) Tooltip hyperlinks

(75) Inventors: Clinton D. Knight, Apex, NC (US); Karen L. Mobley, Apex, NC (US); Timothy Andreas Meserth, Durham, NC (US)

Correspondence Address: IBM CORPORATION, PO BOX 12195, DEPT 9CCA, BLDG 002, RESEARCH TRIANGLE PARK, NC, 27709, US

(73) Assignee: INTERNATIONAL BUSINESS MACHINES CORPORATION, ARMONK, NY

(21) Appl. No.: 10/064,292

(22) Filed: Jun. 28, 2002

(51) Int. Cl. G09G 5/00

(52) U.S. Cl. 345/711

(57) ABSTRACT

A tooltip corresponding to an object on a display screen is displayed on the screen in response to a cursor image being positioned over the object. The tooltip continues to be displayed as the cursor moves from the object to the tooltip, and the tooltip is removed from the screen when the cursor moves off both the object and the tooltip. A portion of the tooltip overlaps the object, so that the cursor can be moved from the object to the overlapping portion of the tooltip, and from the overlapping to the non-overlapping portion of the tooltip. A hyperlink may appear in the tooltip, which can be activated by positioning the cursor over the hyperlink in the tooltip and activating a switch or a button on a pointing device, such a mouse or trackball.

### BACKGROUND OF INVENTION

This invention pertains to computers and other data processing systems and, more particularly, to an information processing system including a software program having pop-up “tooltips” in which the tooltip includes a hyperlink.

In a software application having a graphical user interface, “objects” are typically displayed on screen to permit the user to selectively activate different functions associated with each object. A mouse or other pointing device is used to control the movement of a cursor, and the user activates the function associated with the object by moving the cursor over the object and depressing a switch or “button” on the pointing device, a process commonly known as “clicking” on the object.

An object may consist of text, graphics, or a combination of text and graphics, although the size of an object is usually kept to a minimum to conserve space on the display screen. Because of its limited size, the function associated with each object is often unclear, and “tooltips” are frequently used to provide additional information about an object. A tooltips is a small window containing additional text that pops-up when the user positions the cursor over an object, and disappears when the cursor is moved off the object.

For example, in a popular word processing program, there is an object consisting of a small graphical image of an open book in which a letter “S” is visible on one of the open pages. While the function associated with this object may not be readily apparent simply by viewing the graphical image, placing the cursor over the object causes a small window or “tooltip” to appear adjacent the object with the following text being displayed within the tooltip window: “Spell Check—Check and correct spelling—Ctrl+F1”. Thus, by clicking on this small graphical image of an open book, the spell check function of the word processing program is invoked.

While the primary function of a prior art tooltip is to provide additional information about the associated object, the tooltip itself is often limited in size, which limits the total amount of information that can resides within the tooltip window. Therefore, the invention described below provides a hyperlink within the tooltip window, so that the user can obtain additional information or additional function by clicking on the hyperlink in the tooltip window.

One of the problems that the current invention overcomes is that a prior art hyperlink is activated by clicking on the hyperlink, which requires that the cursor be placed over the hyperlink in the tooltip. However, in a prior art tooltip, as soon as the cursor is moved off the object, the tooltip disappears. Thus, it is not possible to place the cursor over any portion of a prior art tooltip, because the tooltip disappears as soon as the user attempts to move the cursor from the object to the tooltip.

### SUMMARY OF INVENTION

Briefly, in one embodiment, the invention is a computer program product embodied in a machine readable media (such as, but not limited to, a magnetic disk, an optical disk, or a semiconductor memory) that is executable by a processor. The computer program product is for use with a computer system having a display screen, a switch, and a pointing device (such as, but not limited to, a mouse, trackball, pointing stick, or various keyboard controls for cursor movement) for moving a cursor image on the display screen. The computer program product includes program instructions for performing the following steps. Displaying an object on the display screen. Displaying a tooltip on the display screen in response to the positioning of the cursor image over the object. Continuing to display the tooltip in response to the movement of the cursor from the object to the tooltip.

In another embodiment, the invention is a data processing system for use with a display screen, a switch, and a pointing device for moving a cursor image on the display screen. The data processing system includes means for displaying an object on the display screen, and means for displaying a tooltip on the display screen in response to the positioning of the cursor image over the object. Also included are means for continuing to display the tooltip in response to the movement of the cursor from the object to the tooltip.

### BRIEF DESCRIPTION OF DRAWINGS

FIG. 1(a) is an image of a display screen in which an object is displayed and the cursor is positioned off the object.

FIG. 1(b) is an image of a display screen in which an object is displayed and the cursor is positioned over the object, causing a tooltip to appear. The doted image of the cursor indicates its previous position.

FIG. 1(c) is an image of a display screen similar to FIG. 1(b), except that the cursor has been moved from the object to the tooltip to illustrate that tooltip does not disappear when the cursor is moved off the object and onto the tooltip. A hyperlink is also illustrated within the tooltip.

FIG. 1(d), is an image of a display screen similar to FIG. 1(c), except that the hyperlink has been activated to display “linked data” in a new window.

FIG. 1(e), is an image of a display screen similar to FIG. 1(a), except that cursor has been moved off the object, to illustrate that the tooltip disappears when the cursor is no longer positioned over either the object of the tooltip.

FIG. 2 is a block diagram of a computer system capable of executing computer programming code according to the invention described below.

### DETAILED DESCRIPTION

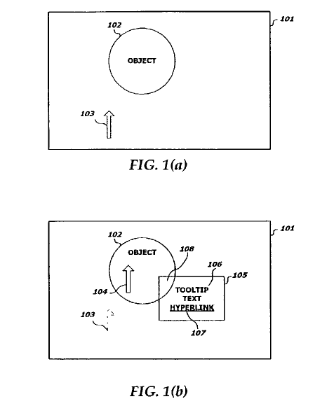

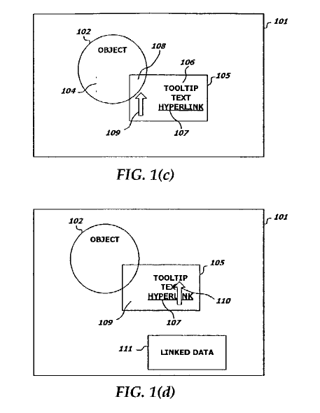

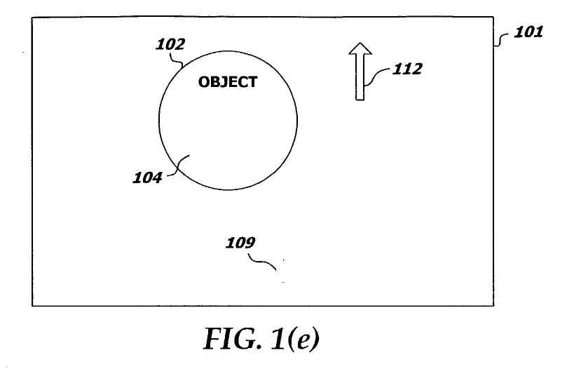

In FIG. 1(a), an object 102 is displayed on a well known display screen 101. Object 102 has an associated function, which can be selectively activated by the user. Common functions associated with objects include print, save, cut, paste, etc. A well known mouse or other pointing device is used to control the movement of a cursor image (illustrated at position 103) on screen 101, and the user activates the function associated with the object by moving the cursor over the object and depressing a switch or “button” on the pointing device, a process commonly known as “clicking on” the object. FIG. 1(a) has been provided primarily to illustrate that no associated tooltip is displayed on screen 101 when the cursor image is off object 102, as illustrated at position 103.

In FIG. 1(b), the cursor image has been moved from previous position 103 (wherein the cursor is shown in phantom form) to position 104 over object 102. Upon moving the cursor over object 102, tooltip 105 appears. Tooltip 105 includes tooltip text 106 (typically in the form of helpful information about the object) and a well known hyperlink 107. Note that a portion 108 of tooltip 105 overlaps object 102.

In FIG. 1(c), the cursor has been moved from previous position 104, to position 109 over tooltip 105. In moving the cursor, it is preferred that it be moved from position 104, across the overlapping portion 108 of tooltip 105, and onto the non-overlapping portion of the tooltip, such as position 109. This figure demonstrates that the tooltip is displayed despite the fact that the cursor has been moved off object 102.

In FIG. 1(d), the cursor image has been moved from position 109 to position 110, which is over hyperlink 107. Upon the activation of the switch associated with the pointing device, a new window appears on screen 101 containing “linked data”, which is text, graphics or other data that is associated with hyperlink 107. In a typical application, tooltips are used to provide “help” information about the object, and the linked data can be used to expand upon the limited amount of help information that can be displayed in a tooltip, which are usually very small windows with limited ability to provide significant amounts of information.

In FIG. 1(e), the cursor has been moved from either position 104 or position 109 to position 112, to demonstrate that the tooltip is removed from display screen 101 when the cursor is moved off both the object and the tooltip.

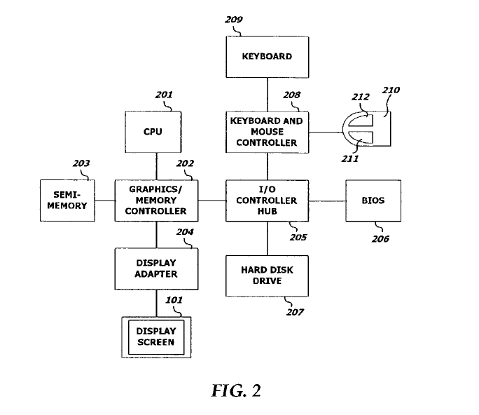

FIG. 2 is a block diagram of a well known computer system capable of executing the exemplary computer code described below and implementing the function of the invention described above. A central processing unit or “CPU” 201 is coupled to a graphics/memory controller 202. Semiconductor memory 203, such as dynamic random access memory or “DRAM” memory is coupled to graphics/memory controller 202. In addition, a display adapter 204, such as an accelerated graphics port or “AGP” graphics adapter, is also coupled to graphics/memory controller 202. Display screen 101 is coupled to display adapter 204.

An Input/Output or “I/O” controller hub 205 is also coupled to graphics/memory controller 202, and a non-volatile memory containing BIOS code is coupled to the I/O controller. A hard disk drive 207 is also coupled to the I/O controller. Hard disk drive 207 is suitable for storing the programming code described below. A keyboard and mouse controller 208 is coupled to the I/O controller, and a mouse 210 and keyboard 209 are coupled to controller 208. While mouse 210 is illustrated in FIG. 2, other well known pointing devices may be used, such as a trackball, pointing stick, or even certain keys of the keyboard may be used to control a cursor image on screen. Mouse 210 includes switches 211 and 212, commonly called buttons, to activate functions associated with the current position of the cursor image on screen. Collectively, the computer system of FIG. 2 provides a means for executing the program functions described in the specification.

Two listings of exemplary computer code follow. This code can be executed in a well known personal computer, or in other well known computers or data processing equipment. The first listing entitled HTML Tool Tip.java extends the tooltip functionality provided the Java Foundation Classes' (JFC) JToolTip. In this class, we override the default behavior of JToolTip, which is to display a short, plain-text, single-line tooltip. Instead, we display a tooltip that renders HTML, providing for hyperlinks, tables, graphics, and line-wrapped, styled text within the tooltip.

The second listing, InfoTable.java, is a class that extends the default table functionality provided by JFC's JTable class. JTable, like other JFC GUI components, provides a default tooltip implementation based on JToolTip. In order to substitute our tooltips for the default, we added the method createToolTip to InfoTable; this method returns an instance of our HTMLToolTip class, rather than the default JToolTip. We also added the method getToolTipLocation that carefully controls the location where the tooltip appears; this allows the user to move the mouse cursor into the tooltip and to interact with its contents.

HTML ToolTip.JAVA
Code Listing

public class HTMLTooITip extends JToomp
{

private final int MAX_WIDTH = 200;
private final int MAX_LINES = 6;
MyHTMLEditorKit htmlKit;
JEditorPane editorPane;
JScrollPane scrollPane;
HelpProviderIntf helpProvider;
/** Constructor for an HTML tool tip.

* @ param component the JComponent that Will display this tooltip
* @ param helpProviderIN the help provider that will display more info
* if this tooltip contains any navigable HTML links
*/

public HTMLToolTip(JComponent component, HelpProviderIntf helpProvideriN)
{

super();
helpProvider = helpProviderIN;
setComponent(component);
setLayout(new BorderLayout());
setBorder(null);
htmlKit = new MyHTMLEditorKit();
editorPane = new JEditorPane();
editorPane.addHyperlinkListener(new Hyperactive());
editorPane.setEditable(false);
editorPane.setEditorKit(htmlKit);
Border border = (Border) UIManager.get(“HTMLToolTip.border”);
if (border == null)

border = new CompoundBorder(new LineBorder(UIManager.getColor(“textHighlight“), 1),

new LineBorder(editorPane.getBackground(), 3));

setBorder(border);
//scrollPane = new JScrollPane(editorPane);
add(editorPane, BorderLayout.CENTER);

}
/** Set the text for this tooltip.

* @ param tipText the string to display
*/

public void setTipText(String tipText)
{

if (tipText == null)

{

setPreferredSize(new Dimension(0, 0));
return;

}
BufferedReader in = new BufferedReader(new StringReader(tipText));
try
{

editorPane.setDocument(htmlKit.createDefaultDocument());
((HTMLDocument) editorPane.getDocument()).setBase(HelpSystem.getBaseURL());
htmlKit.read(in, editorPane.getDocument(), 0);

}
catch (Exception e)
{

// failed to initialize tooltip, so show nothing
setPreferredSize(new Dimension(0, 0));
return;

}
// set the size of this tool tip
FontMetrics metrics = Toolkit.getDefaultToolkit().getFontMetrics(new Font(“SansSerif”,

Font.PLAIN, 11));

int totalWidth = metrics.stringWidth(visibleText(tip text));
double rawWidth = Math.min(totalWidth, MAX_WIDTH);
int width = (int) rawWidth + 50; //pad for scrollbars, border, etc.
//int lines = (int) Math.min(Math.cell(totalWidth/rawWidth) + 0.5, MAX_LINES);
int rawLines = (int) Math.ceil(totalWidth/rawWidth);
int lines = rawLines + getExtraLineCount();
int rawHeight = (int) (metrics.getHeight() * 1.25 * lines); // fudge factor to handle space added by

line wrapping

int height = rawHeight + 18; // pad for scrollbars, border, etc.
setPreferredSize(new Dimension(width, height));
// in case we must scroll, start at the top
editorPane.setCaretPosition(1);

}
/** JDK 1.3 on Windows works fine, but the 1.1.8 JEditorPane adds an extra blank line to the top of

the

* document it is rendering, causing the tooltip to be cut off. Other OS's seem to need this extra

line

* all the time.
* @ retum 0 for JDK 1.3 on Windows, else 1
*/

private int getExtraLinecount()
{

if (UIManager.getLookAndFeel().getName().equals(“Windows”) &&

System.getProperty(“java.version”).startsWith(“1.3”))

return 0;
else

return 1;

}
private static final double FACTOR = 0.85;
/** This method takes an HTML string and returns only the visible portion

* of it, that is, the text between the HTML tags.
* @ param htmlText the HTML input string
* @ return the text between the HTML tags
*/

private String visibleText(String htmlText)
{

String token;
boolean in Tag = false;
StringTokenizer st = new StringTokenizer(htmlText, “<”, true);
StringBuffer visibleText = new StringBuffer();
while (st.hasMoreTokens())
{

token = (inTag) ? st.nextToken(“>”):st.nextToken(“<”);
if (token.equals(“<”))

inTag = true;

else if (token.equals(“>”))

inTag = false;

else if (!inTag)

visibleText.append(token);

}
return visibleText.toString();

}
/** The hyperlink listener used by the HTMLTooITip class.*/
class Hyperactive implements HyperlinkListener
{

public void hyperlinkUpdate(HyperlinkEvent e)
{

if (e.getEventType() == HyperlinkEvent.EventType.ACTIVATED)
{

JEditorPane pane = (JEditorPane) e.getSource();
try
{

if ((e.getURL() != null) && !e.getURL().getProtocol().toLowerCase().startsWith(“http”))
{

helpProvider.activateHelp(e.getURL());

}
if ((e.getDescription() !=null) &&

(e.getDescription().length() > 0) &&
!e.getDescription().toLowerCase().startsWith(“http:”))

{

helpProvider.activateHelp(HelpSystem.getURLFromFilename(e.getDescription()));

}

}
catch (Throwable t)
{

JCRMUtil.ErrorLog(JCRMUtil.throwableStackTraceToString(t));

}

}

}

}
class MyHTMLEditorKit extends HTMLEditorKit
{
/**

* Create an uninitialized text storage model
* that is appropriate for this type of editor.
*
* @ return the model
*/
public Document createDetaulDocument()
{

HTMLDocument document = (HTMLDocument) super.createDefaultDocument();
document.setAsynchronousLoadPriority(−1)-;
return document;

}

}

}
Info Table JAVA Code
class IntoTable extends JTable
{

/** Our custom renderer that can render icons to highlight problems. */
InfoTableCellRenderer renderer;
/** Help provider that displays help invoked from tooltips. */
HelpProviderIntf helpProvider;
/** Returns a new instance of InfoTable.

* @ param model the table model
*/

InfoTable(InfoTableModel model, HelpProviderIntf helpProviderIN)
{

super(model);
helpProvider = helpProviderIN;
setRowSelectionAllowed(false);
setColumnSelectionAllowed(false);
setCellSelectionEnabled(false);
setAutoResizeMode(JTable.AUTO_RESIZE_LAST_COLUMN):
sizeColumnsToFit(−1);
setShowGrid(false);
setIntercellSpacing(new Dimension(0, 0));
setGridColor(UIManager.getColor(“Button.background”));
getColumnModel().addColumnModelListener(this);
renderer = new InfoTableCellRenderer();
getAccessibleContext().setAccessibleName(JCRMUtil.getNLSString(“details Table”));

}
/** We listen for TableColumnModelEvents so that we may add our custom

* TableCellRenderer to each column that gets created.
* @ param evt the event describing the creation of a table column
*/

public void columnAdded(TableColumnModelEvent evt)
{

super.columnAdded(evt);
TableColumnModel columnModel = (TableColumnModel) evt.getSource();
columnModel.getColumn(evt.getToIndex()).setCellRenderer(renderer);

}
/** Work around a bug in JComponent. Launch is an applet in a frame, but

* this method in JComponent stopped at the applet: we need the frame.
* @ retum the top level container for this component
*/

public Container getTopLevelAncestor()
{

for (Container p = this; p != null; p = p.getParent())

if (p instanceof Window∥((p instanceof java.applet.Applet) && (p.getParent() == null)))

return p;

return null;

}
/** Returns our custom HTMLToolTip object.

* @ return an HTML tool tip
*/

public JToolTip creater ToolTip()
{

HTMLToolTip tip = new HTMLToolTip(this, helpProvider);
return tip;

}
/** Returns the location for our custom HTMLToolTip object.

* @ param event the MouseEvent that determines where the cursor is
* @ return the location for the tool tip
*/

public Point getToolTipLocation(MouseEvent event)
{

//Locate the renderer under the event location
Point p = event.getPoint();
int hitColumnIndex = columnAtPoint(p);
int hitRowIndex = rowAtPoint(p);
Rectangle cellRect = getCellRect(hitRowIndex, hitColumnIndex, false);
return new Point(10, cellRect.y + cellRect.height − 3);

}

}

1. A computer program product embodied in a machine readable media and executable by a processor, said computer program product for use with a computer system having a display screen, a switch, and a pointing device for moving a cursor image on the display screen, said computer program product comprising program instructions for performing the steps of:
displaying an object on the display screen;
displaying a tooltip on the display screen in response to the positioning of the cursor image over the object,
continuing to display the tooltip in response to the movement of the cursor from the object to the tooltip.

2. The computer program product of claim 1, wherein the tooltip has an overlapping portion that overlaps the object on the display screen, and a non-overlapping portion that does not overlap the object on the display screen, and the step of continuing to display the tooltip is in response to the movement of the cursor from the object to the overlapping portion of the tooltip, followed by the movement of the cursor from the overlapping portion to the non-overlapping portion of the tooltip.

3. The computer program product of claim 1, further comprising program instructions for performing the step of removing the tooltip from the display screen in response to the movement of the cursor both off the object and off the tooltip.

4. The computer program product of claim 2, wherein the tooltip includes a hyperlink displayed within the tooltip, further comprising program instructions for performing the step of displaying on the display screen linked data in response to the cursor being positioned over the hyperlink within the tooltip and the activation of the switch.

5. The computer program product of claim 3, wherein the tooltip includes a hyperlink displayed within the tooltip, further comprising program instructions for performing the step of displaying on the display screen linked data in response to the cursor being positioned over the hyperlink within the tooltip and the activation of the switch.

6. The computer program product of claim 1, further comprising program instructions for performing the step of removing the tooltip from the display screen in response to the movement of the cursor both off the object and off the tooltip.

7. The computer program product of claim 6, wherein the tooltip includes a hyperlink displayed within the tooltip, further comprising program instructions for performing the step of displaying on the display screen linked data in response to the cursor being positioned over the hyperlink within the tooltip and the activation of the switch.

8. The computer program product of claim 1, wherein the tooltip includes a hyperlink displayed within the tooltip, further comprising program instructions for performing the step of displaying on the display screen linked data in response to the cursor being positioned over the hyperlink within the tooltip and the activation of the switch.

9. A data processing system for use with a display screen, a switch, and a pointing device for moving a cursor image on the display screen, said data processing system comprising:
means for displaying an object on the display screen;
means for displaying a tooltip on the display screen in response to the positioning of the cursor image over the object; and
means for continuing to display the tooltip in response to the movement of the cursor from the object to the tooltip.

10. The data processing system of claim 9, wherein the tooltip has an overlapping portion that overlaps the object on the display screen, and a non-overlapping portion that does not overlap the object on the display screen, and the means for continuing to display the tooltip is in response to the movement of the cursor from the object to the overlapping portion of the tooltip, followed by the movement of the cursor from the overlapping portion to the non-overlapping portion of the tooltip.

11. The data processing system of claim 10, further comprising means for removing the tooltip from the display screen in response to the movement of the cursor both off the object and off the tooltip.

12. The data processing system of claim 11, wherein the tooltip includes a hyperlink displayed within the tooltip, further comprising means for displaying on the display screen linked data in response to the cursor being positioned over the hyperlink within the tooltip and the activation of the switch.

13. The data processing system of claim 10, wherein the tooltip includes a hyperlink displayed within the tooltip, further comprising means for displaying on the display screen linked data in response to the cursor being positioned over the hyperlink within the tooltip and the activation of the switch.

14. The data processing system of claim 9, further comprising means for removing the tooltip from the display screen in response to the movement of the cursor both off the object and off the tooltip.

15. The data processing system of claim 14, wherein the tooltip includes a hyperlink displayed within the tooltip, further comprising means for displaying on the display screen linked data in response to the cursor being positioned over the hyperlink within the tooltip and the activation of the switch.

16. The data processing system of claim 9, wherein the tooltip includes a hyperlink displayed within the tooltip, further comprising means for displaying on the display screen linked data in response to the cursor being positioned over the hyperlink within the tooltip and the activation of the switch.
